(19) United States
(12) Patent Application Publication
(10) Pub. No.: US 2013/0094526 A1
(43) Pub. Date: Apr. 18, 2013

(54) MEMS Q-Switched Nd:YLF Monoblock Laser

(71) Applicants: John E. Nettleton, Fairfax Station, VA (US); Dallas N. Barr, Woodbridge, VA (US)

(72) Inventors: John E. Nettleton, Fairfax Station, VA (US); Dallas N. Barr, Woodbridge, VA (US)

(73) Assignee: United States of America, as represented by the Secretary of the Army, Fort Belvoir, VA (US)

(21) Appl. No.: 13/273,751

(22) Filed: Oct. 14, 2011

(51) Int. Cl. H01S 3/11

(52) U.S. Cl. 372/10

(57) ABSTRACT

A monoblock laser cavity incorporates optical components for a short-pulse laser. These optical components are ‘locked’ into alignment forming an optical laser cavity for flash lamp or diode laser pumping. The optical laser cavity does not need further optical alignment upon fabrication. The improvements upon the original Monoblock design replaces the Cr:YAG Q-switch component with a MEMS scanner and replaces the Nd:YAG with Nd:YLF laser material.

### GOVERNMENT INTEREST

The invention described herein may be manufactured, used, sold, imported, and/or licensed by or for the Government of the United States of America.

### FIELD OF THE INVENTION

This invention relates in general to laser cavities, and more particularly to a monoblock laser cavity capable of producing a short-pulse, eye safe laser.

### BACKGROUND OF THE INVENTION

Laser range finders are becoming an increasingly vital component in high precision targeting engagements. The precise and accurate range to target information is an essential variable to the fire control equation of all future soldier weapons. This information is easily, and timely, provided by laser range finders.

Unfortunately, current fielded laser range finders are bulky, heavy and expensive. These laser range finders were not developed with the individual soldier and his special needs in mind.

The Monoblock Laser makes the development/fabrication of a very low cost, compact laser range finder feasible. The Monoblock Laser is the cornerstone of the U.S. Army's AN/PSQ-23 Small Tactical Optical Ranging Module (STORM) of which thousands have been fielded.

### SUMMARY OF THE INVENTION

A Q-switched monoblock laser can be based on a Micro-Electrical-Mechanical-System (MEMS) scanner. In one aspect, a lower cost MEMS Q-switch component is used to improve the optical-to-optical efficiency and to provide output emission control of the Nd:YLF monoblock laser output pulse energy. Also, use of the Nd:YLF laser material provides for a self-polarized laser emission, a longer pump time and improved beam quality.

More generally, a monoblock laser cavity is disclosed. Such a laser cavity comprises a Q-switch; a laser gain medium based on a suitable laser material; and an optical parametric oscillator having an output coupler coating. At least said laser gain medium and said optical parametric oscillator are disposed as optical components in an arrangement along an optical axis of the laser cavity on a YAG pallet.

### BRIEF DESCRIPTION OF THE DRAWINGS

Additional advantages and features will become apparent as the subject invention becomes better understood by reference to the following detailed description when considered in conjunction with the accompanying drawings wherein:

FIG. 1 shows a monoblock laser cavity based on a Cr:YAG Q-switch; and

FIG. 2 shows an exemplary embodiment of an Nd:YLF monoblock laser cavity based on a MEMS Q-switch.

### DETAILED DESCRIPTION

A Q-switched monoblock laser is disclosed. An original monoblock laser cavity is based on Cr:YAG passive Q-switch optical components. However, exemplary embodiments based on a Micro-Electrical-Mechanical-System (MEMS) scanner or resonant optical scanner are disclosed. A scanner-based Q-switched Nd:YLF monoblock laser can be used in lieu of a monoblock cavity based on a Cr:YAG passive Q-switch.

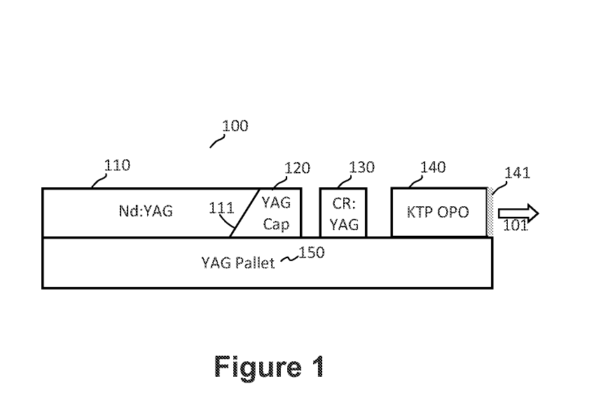

FIG. 1 depicts a monoblock laser cavity 100 based on a Cr:YAG Q-switch 130. As exemplified in FIG. 1, a laser gain medium has an Nd:YAG portion 110 partitioned by a Brewester's angle 111 from a YAG cap 120. Although the laser gain medium is disclosed as Nd:YAG, any of the numerous suitable laser materials can also be used. Said laser gain medium is followed by a CR:YAG passive Q-switch 130. The Q-switch 130 is then followed by a potassium titanyl phosphate (KTP) optical parametric oscillator (OPO) 140 having an output coupler coating 141. Said monoblock laser components rest on a YAG Pallet 150 as depicted in FIG. 1.

The Cr:YAG passive Q-switch (e.g., 130) works by holding off lasing in the Monoblock cavity until the proper laser threshold (think of it as a photonic pressure), as determined primarily by the optical density of the Cr:YAG Q-switch 130, is reached. Until the lasing threshold is reached, the Cr:YAG is opaque at the lasing wavelength and prevents or holds off the lasing operation. But once this lasing threshold (pressure) is reached, the Cr:YAG rapidly (within nano-seconds) bleaches and becomes transparent to the laser wavelength. The laser (under pressure) is emitted 101 in a short pulse until the Cr:YAG reverts back to its opaque state.

Unfortunately, the Cr:YAG passive Q-switch 130 does not become 100% transparent to the laser wavelength when it bleaches (it typically bleaches to about 50% transparency). The lack of total transparency means that the Cr:YAG passive Q-switch 130 is providing losses in the laser cavity 100 which leads to lower optical input to optical output efficiency.

The laser build up occurs in the laser gain medium which is Nd:YAG (e.g., 110) for the original Monoblock as seen in FIG. 1. The Nd:YAG material is pumped either by a flash lamp or by laser diodes. Much more control and greater electrical energy efficiency is achieved with laser diode pumping.

The fluorescence lifetime of Nd:YAG is about 230 micro-seconds. This is the average time the laser molecule stays in its excited state before emitting a photon which sets the time limits that the laser cavity can be pumped (efficiently or effectively). The pump time also determines the amount of energy that can be deposited into the laser cavity (pump power×time=energy into laser cavity) for future extraction.

Another shortcoming of Nd:YAG (e.g., 110) in the Monoblock 100 is that the natural emissions from Nd:YAG is non-polarized. The KTP OPO (optical parametric oscillation) cavity of the Monoblock requires that the 1064 nm laser input be polarized for conversion to the sought after eye-safe wavelength of 1573 nm. Polarization is accomplished in the Monoblock by placing a cut at the Brewster angle 111 at the end of the Nd:YAG laser crystal 110. A YAG cap 120 is added to correct for the angular deflection that would have occurred without it, in other words it keeps the beam going straight.

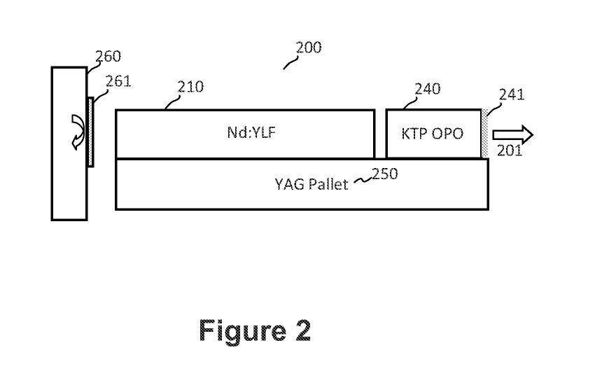

A different exemplary embodiment replaces the Cr:YAG Passive Q-Switch (130) functionality with an active Q-Switch (e.g., 260) as shown in FIG. 2. Also, Nd:YLF laser material shown as 210 in FIG. 2 replaces the Nd:YAG laser material shown as 110 FIG. 1. FIG. 2 genetically depicts an exemplary embodiment of an Nd:YLF monoblock laser cavity 200 based on a scanner-based active Q-switch 260. Such a scanner Q-switch can be based on a Micro-Electrical-Mechanical-System (MEMS) scanner or a resonant optical scanner.

As exemplified in FIG. 2, an Nd:YLF laser gain medium 210 is used. Alternatively, the active laser medium can be Nd:YAG (e.g., as configured in FIG. 1), or any of the numerous suitable laser materials. Said Nd:YLF laser gain medium 210 is followed by a potassium titanyl phosphate (KTP) optical parametric oscillator (OPO) 240 having an output coupler coating 241 at its emitting end 201. Said ND:YLF laser gain medium 210 and said optical parametric oscillator 240 are disposed as an arrangement on a YAG Pallet 250 as depicted in FIG. 2. The YAG Pallet 250 arrangement is preceded by a scanner Q-switch 260 based on either a MEMS scanner or a resonant optical scanner having a resonant mirror end 261 facing another end of said YAG pallet arrangement opposite to said emitting end 201 having said output coupler coating 241 such that the scanner resonant mirror 261 acts as a Q-switch.

The MEMS Scanner Active Q-Switch 260 is a resonant scanning device. Two commercially available scanners were tried with success. One scanner mirror is a single axis MEMS scanning based on a reflective mirror (OPUS Microsystems® BA0050). An alternative scanner mirror is an SC-5 resonant optical scanner available from Electro-Optical Products Corp. The disclosure encompasses those and any such commercially available scanning mirror suitable for use as a Q-switch when referring to a scanner-based Q-switch, a MEMS scanner or a MEMS mirror. The scanning mirror 261 is swept back and forth along the optical axis of the laser cavity 200. When the MEMS scanning mirror 261 is not aligned with the output coupler (e.g., 241) of the Monoblock Laser Cavity (outer face of the KTP OPO component 240) no lasing (hold off) can occur. But during a sweep, the MEMS mirror 261 will precisely align with the output coupler and cause the built-up laser energy to emit 201 in a short pulse. There is no loss (blockage) of the laser during the Q-switching like there is in the Cr:YAG Passive Q-Switch case (e.g., FIG. 1) which leads to very efficient optical-to-optical output.

The resonant frequency of the MEMS scanner (260) is selected based on the allowable pump time (approximately the fluorescence lifetime of the gain media). The period of the resonant frequency should be longer than the pump time. For example, an exemplary monoblock laser cavity using Nd:YAG as the gain media has a fluorescence lifetime of about 230 micro-seconds which leads to a MEMS scanner resonant frequency of about 4.3 KHz or less.

The Pump will be synchronized with the MEMS Scanner Active Q-Switch which provides an electronic signal, such as a sine wave, that is correlated to the mirror position. The pump will begin at the precise time before the MEMS mirror 261 reaches the Q-Switch position (parallel with the output coupler).

The Nd:YAG laser material is replaced with Nd:YLF laser material. (See, 210 of FIG. 2.) The Nd:YLF laser material has a fluorescence lifetime of about 485 micro-seconds, more than double that of Nd:YAG. If a laser diode pump source is used, this allows one to reduce the number of diodes required to half that is needed for Nd:YAG.

Also notice, as shown in FIG. 2, that the Nd:YLF is a simple sqrod. No Brewster cuts are required, Nd:YLF is self-polarizing.

A filtered photodetector tuned to the laser wavelength of the cavity (e.g. 1053 nm for the Nd:YLF) which tracks the fluorescence building up inside the cavity is also added. This will allow control of the final output laser emission over temperature extremes.

### Advantages

The variously described exemplary embodiments improve the optical efficiency of the monoblock laser and allows active control of the output laser emission (pulse energy). The MEMS Scanner Active Q-Switch also has the potential of being much less costly than the Cr:YAG Passive Q-switch. An electronic chip versus a semi-precious, grown laser crystal.

The use of Nd:YLF laser material requires less than half the number of pump diodes as compared to Nd:YAG laser material. This can translate into a significant cost savings as the laser diode pump is extremely costly.

Nd:YLF also exhibits low thermal lensing which can lead to better beam quality, lower output beam divergence. The lower output beam divergence means that smaller optics would be required to provide the necessary collimation needed by the laser range finding system.

The Improved Monoblock Laser Cavity is still a simple module that requires none of the labor extensive alignment procedures as current laser range finder solid state sources. No optical holders have to be fabricated, no complex engineering is required to design the optical cavity, and no precise laser cavity alignments) are required. Production labor and material costs are greatly reduced.

The Improved Monoblock Laser Cavity is a modular component. The modularity lends to ease of design for different pump sources. It can be incorporated in a flash lamp pumped or laser diode pumped system.

### Applications

The variously described embodiments may be used as the laser source in very compact laser range finders. The Monoblock generates eye safe laser output for eye safe laser range finding. These laser range finders have both military and commercial applications. The compact design of the Improved Monoblock Laser Cavity also lends itself to placement in other laser-based portable/hand-held devices. These may be medical devices, industrial tools or scientific equipment that would benefit from the size/weight reduction, dependable performance, and low cost.

It is obvious that many modifications and variations of the present invention are possible in light of the above teachings. It is therefore to be understood that within the scope of the appended claims, the invention may be practiced otherwise than as described.

What is claimed is:

1. A monoblock laser cavity, comprising:
a Q-switch;
a laser gain medium based on a suitable laser material; and
an optical parametric oscillator having an output coupler coating, wherein at least said laser gain medium and said optical parametric oscillator are disposed as optical components in an arrangement along an optical axis of the laser cavity on a YAG pallet.

2. The monoblock laser cavity according to claim 1, wherein said laser gain medium has an Nd:YAG portion partitioned by a Brewester's angle from a YAG cap, and wherein said Q-switch is a CR:YAG passive Q-switch disposed on said YAG pallet in said arrangement along the optical axis of the laser cavity between said laser gain medium and said optical parametric oscillator.

3. The monoblock laser cavity according to claim 2, wherein the fluorescence lifetime of Nd:YAG is about 230 micro-seconds, and wherein a 1064 nm laser input is polarized by said Nd:YAG partition by a Brewester's angle for conversion to an eye-safe wavelength of about 1573 nm.

4. The monoblock laser cavity according to claim 1, wherein said optical parametric oscillator having an output coupler coating is a potassium titanyl phosphate optical parametric oscillator having an output coupler coating.

5. The monoblock laser cavity according to claim 1, wherein said laser gain medium is an Nd:YLF self-polarizing laser gain medium.

6. The monoblock laser cavity according to claim 5, comprising a filtered photodetector tuned to a 1053 nm laser wavelength of the laser cavity for control of the output laser emission over a temperature range.

7. The monoblock laser cavity according to claim 5, wherein said optical components are disposed in an alignment to form an optical laser cavity for flash lamp or diode laser pumping, wherein Nd:YLF laser material has a fluorescence lifetime of about 485 micro-seconds, whereby a significant reduction in the number of laser diode pumps can be realized for Nd:YLF laser material as compared to Nd:YAG laser material.

8. The monoblock laser cavity according to claim 5, wherein said Q-switch is based on either a MEMS scanner or a resonant optical scanner having a resonant mirror end facing another end of said YAG pallet arrangement opposite to an emitting end having an output coupler coating such that a mirror of said scanner resonates to act as an active Q-switch.

9. The monoblock laser cavity according to claim 8, wherein said mirror resonates by sweeping back and forth along the optical axis of the laser cavity, wherein the mirror precisely aligning with the output coupler during a sweep causes a build-up of laser energy to emit in a short pulse without blockage.

10. The monoblock laser cavity according to claim 8, wherein the resonant frequency of the scanner is selected based on an allowable pump time.

11. The monoblock laser cavity according to claim 8, wherein an electronic signal, such as a sine wave, is correlated to the mirror position such that a pump can begin at the precise time before the scanner mirror reaches a parallel position.

12. The monoblock laser cavity according to claim 8, wherein said MEMS scanner is packaged as an electronic chip, and wherein a precise laser cavity alignment is not necessary.

13. The monoblock laser cavity according to claim 8, wherein said monoblock laser cavity is a modular component capable of interfacing with a pump source, incorporation in a flash lamp pumped system, or incorporation in a laser diode pumped system.

14. A compact laser range finder having the monoblock laser cavity according to claim 8 as its laser source.

15. A portable or hand-held laser device based on said monoblock laser cavity according to claim 8, wherein said laser device is for medical, industrial or scientific applications where size/weight reduction, dependable performance, and/or low cost are design considerations.

16. The monoblock laser cavity according to claim 8, wherein Nd:YLF exhibits low thermal lensing for lower output beam divergence.
